(19) United States
(12) Patent Application Publication
(10) Pub. No.: US 2012/0234661 A1
(43) Pub. Date: Sep. 20, 2012

(54) SWITCH DEVICE

(75) Inventors: Takashi Nose, Kasugai-shi (JP); Hidetoshi Yoshikawa, Komaki-shi (JP); Takuya Nishioka, Kasugai-shi (JP); Shiho Nakano, Kuwana-shi (JP)

(73) Assignee: OMRON AUTOMOTIVE ELECTRONICS CO., LTD., Komaki (JP)

(21) Appl. No.: 13/418,996

(22) Filed: Mar. 13, 2012

(30) Foreign Application Priority Data
Mar. 14, 2011 (JP) 2011-056022

(51) Int. Cl. H01H 13/72

(52) U.S. Cl. 200/5 D

(57) ABSTRACT

A switch device includes an operation knob; a supporting shaft that swingably supports the operation knob; a board substantially parallel to the supporting shaft; a first push button switch located on one side of a surface that includes the supporting shaft and is perpendicular to the board, and provided on the board to be operated by swing of the operation knob; a second push button switch located on another side of the perpendicular surface, and provided on the board to be operated by the swing of the operation knob; and a third push button switch intersecting the perpendicular surface, and provided on the board to be operated by the swing of the operation knob. A first point of effort of a force acting on the first push button switch in the operation knob is located on the one side, spaced from the perpendicular surface.

### BACKGROUND OF THE INVENTION

1. Technical Field

The present invention relates to a switch device, and particularly to a switch device enabling two-stage operation preferable for a power window switch for vehicle.

2. Related Art

Conventionally, for example, in order to open and close windows of a vehicle such as automobile, there has been known a switch that includes a plurality of rubber switches (push button switches), thereby enabling two-stage operation from demand for operability, reliability and the like.

For example, in Japanese Patent Application Laid-Open No. H3-236124, there is disclosed a seesaw switch (robber switch) including a total of four push switches in a state where two push switches are included on each side with a supporting shaft of the seesaw switch interposed, wherein the two push switches on one side are operated by push bodies different in actuation stroke, by which two-stage operation is enabled.

In the above-described seesaw switch, the two push button switches are required for inclination of the operation knob in one direction. The two push buttons for inclination in another direction are also required, and as a result, a total of four push buttons are required. Aside from these, five operation rods that each transmit a force from the operation knob are required. The operation rods are required for the respective four switches, and further, the operation rod for generating operation feeling is required. Accordingly, the number of components is large.

Moreover, in Japanese Patent Application Laid-Open No. H8-111142, there is disclosed a seesaw switch that includes an operation knob supported swingably around a supporting shaft, a pair of actuation plates inclined by a pressing force from this operation knob, and a pair of push switches that is arranged under each of these actuation plates, and is operated in accordance with inclination angle of these actuation plates, which enables two-stage operation.

Moreover, in Japanese Patent Application Laid-Open No. 2004-139945, there is disclosed a seesaw switch including a swingable operation knob, an actuation plate having an approximately L-shape in a plan view, which actuation plate is pressed and driven by the operation knob, and a total of three push switches; two push switches supporting both end portions of the actuation plate and one push switch supporting a bent portion (central portion) of the actuation plate. A driver extending from the operation knob is brought into contact with a portion closer to one of the push switches in both end portions rather than the push switch in the central portion in the actuation plate, which allows the actuation plate to sequentially operate one of the push switches in both the end portions and the push switch in the central portion in response to a descending amount of the driver. Also, the push switch in the other end portion and the push switch in the central portion are sequentially operated in response to the descending amount of the driver, which enables the two-stage operation.

In this seesaw switch, the three push button switches are used. Further, the actuation plate to cause the operation knob to operate the push button switches is used. Moreover, in order to realize the two-stage operation by this seesaw switch, a certain amount of distance needs to be assured between the switches, and the actuation plate is formed into the L shape in the present literature, which makes a structure thereof larger.

In Japanese Patent Application Laid-Open No. H10-294041, there is disclosed a monitor switch that performs both switching selection of a plurality of display screens displayed on a display screen, and function decision corresponding to the selected display by operation of one switch operation knob. This monitor switch is a monitor switch including a slider held displaceably, an operation knob (seesaw type knob) pivotally supported so as to be turnable in housing outer end portion of this slider, a pair of push rods that works with the turning displacement of this operation knob, and a stroke switch arranged close to a housing inner end portion of the above-described slider, and rubber switches arranged close to housing inner end portions of the pair of push rods, wherein a motion stroke of the stroke switch opened and closed in response to a motion of the slider is set to be smaller than a stroke of the rubber switches opened and closed in response to motions of the push rods. While this monitor switch is not a switch that enables the two-stage operation, it resembles the switch of Japanese Patent Application Laid-Open No. 2004-139945 in that a total of three push switches are used.

Moreover, while in the monitor switch disclosed in Japanese Patent Application Laid-Open No. H10-294041, the number of the required push button switches is three as the whole, the two-stage operation is not enabled. That is, the push button switch in the center functions by pushing the central portion of the operation knob, and the push button switches at both ends function in response to the motion of the slider, so that the central push button switch and the push button switches at both the ends do not have an interlocking property.

### SUMMARY

One or more embodiments of the present invention is to provide a switch device that reduces the number of components and required space while enabling two-stage operation of a switch by employing a new structure.

In accordance with one aspect one or more embodiments of the present invention, there is provided a switch device including an operation knob, a supporting shaft that swingably supports the operation knob, a board substantially parallel to the supporting shaft, a first push button switch located on one side of a surface that includes the supporting shaft and is perpendicular to the board, and provided on the board to be operated by swing of the operation knob, a second push button switch located on another side of the perpendicular surface, and provided on the board to be operated by the swing of the operation knob, and a third push button switch intersecting the perpendicular surface, and provided on the board to be operated by the swing of the operation knob, wherein a first point of effort of a force acting on the first push button switch in the operation knob is located on the one side, spaced from the perpendicular surface, a second point of effort of a force acting on the second push button switch in the operation knob is located on the other side, spaced from the perpendicular surface, and a third point of effort of a force acting on the third push button switch in the operation knob is located in the vicinity of the perpendicular surface.

According to this, there can be provided a power window switch for vehicle that enables the two-stage operation, and reduces the number of components, assembling manhours, space and the like.

Furthermore, the switch device according to one or more embodiments of the present invention may further include a case including the supporting shaft, a first operation rod that transmits the force from the first point of effort to the first push button switch, a second operation rod that transmits the force from the second point of effort to the second push button switch, and a third operation rod that transmits the force from the third point of effort to the third push button switch, wherein the board, the first operation rod, the second operation rod, and the third operation rod are arranged inside the case, the first operation rod and a lower surface of the operation knob, and the second operation rod and the lower surface of the operation knob are in contact with each other, and a portion where the third operation rod and the lower of the operation knob are in contact with each other, which is the third point of effort, has a shape in which as inclination of the swing of the operation knob becomes larger, a distance from the supporting shaft to the portion in contact becomes shorter.

Furthermore, a magnitude of the inclination by the swing of the operation knob that conducts or cuts off each of the first push button switch and the second push button switch may be smaller than a magnitude of the inclination by the swing of the operation knob that conducts or cuts off the third push button switch.

Furthermore, the first push button switch is conducted or cut off by inclining the operation knob in one direction, and a third push button switch is conducted or cut off by further inclining the operation knob in the one direction, while the second push button switch is conducted or cut off by inclining the operation knob in another direction, and the third push button switch is conducted or cut off by further inclining the operation knob in the other direction.

Moreover, in accordance with another aspect of one or more embodiments of the present invention, there is provided a switch device including an operation knob, a supporting shaft that swingably supports the operation knob, a board substantially parallel to the supporting shaft, a first push button switch located on one side of a surface that includes the supporting shaft and is perpendicular to the board, and provided on the board to be operated by swing of the operation knob, a second push button switch located on another side of the perpendicular surface, and provided on the board to be operated by the swing of the operation knob, a third push button switch intersecting the perpendicular surface, and provided on the board to be operated by the swing of the operation knob, a first operation rod that is provided on the one side of the perpendicular surface, and presses the first push button switch by inclination in a first direction of the operation knob, a second operation rod that is provided on the other side of the perpendicular surface, and presses the second push button switch by inclination in a second direction of the operation knob, and a third operation rod that is provided at a position intersecting the perpendicular surface, and presses the third push button switch by the inclination in the first or second direction of the operation knob.

As described above, according to one or more embodiments of the present invention, there can be provided a switch device that enables two-stage operation preferable for a power window switch for vehicle, in which the number of components, assembling manhours, space and the like are reduced, as compared with a conventional switch device.

### BRIEF DESCRIPTION OF THE DRAWINGS

FIG. 1A is a top view, FIG. 1B is a side view, FIG. 1C is a front view, and

FIG. 1D is a back view, showing a switch device of a first embodiment of the present invention;

FIG. 2A is a cross-sectional view along A-A, FIG. 2B is a cross-sectional view along B-B, FIG. 2C is a cross-sectional view along C-C, and FIG. 2D is a cross-sectional view along D-D, showing the switch device of the first embodiment of the present invention;

FIG. 3A is a top view, and FIG. 3B is a side view, showing the switch device in a state where an operation knob is not attached in the first embodiment of the present invention;

FIG. 4A is a bottom view, and FIG. 4B is a perspective view, showing the operation knob in the first embodiment of the present invention;

FIGS. 5A to 5D are operation explanatory views (cross-sectional views) of the switch device in the first embodiment of the present invention, FIG. 5A showing manual-up, FIG. 5B showing auto-up, FIG. 5C showing manual-down, FIG. 5D showing auto-down;

FIGS. 6A to 6D are perspective views showing the switch device of the first embodiment of the present invention, FIG. 6A showing the whole, FIG. 6B showing a state where the operation knob is removed, FIG. 6C showing a state where side surfaces of a case are removed, and FIG. 6D showing a state where operation rods are removed; and

FIGS. 7A to 7D are operation explanatory views showing operation of a switch device in a second embodiment of the present invention, FIG. 7A showing a neutral state, FIG. 7B showing a state where a first stage is conducted, FIG. 7C showing a state where a second stage is conducted, and FIG. 7D showing an enlarged view of a portion where an operation rod and a lower surface of the operation knob are in contact with each other.

### DETAILED DESCRIPTION

Hereinafter, referring to the drawings, respective embodiments according to the present invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

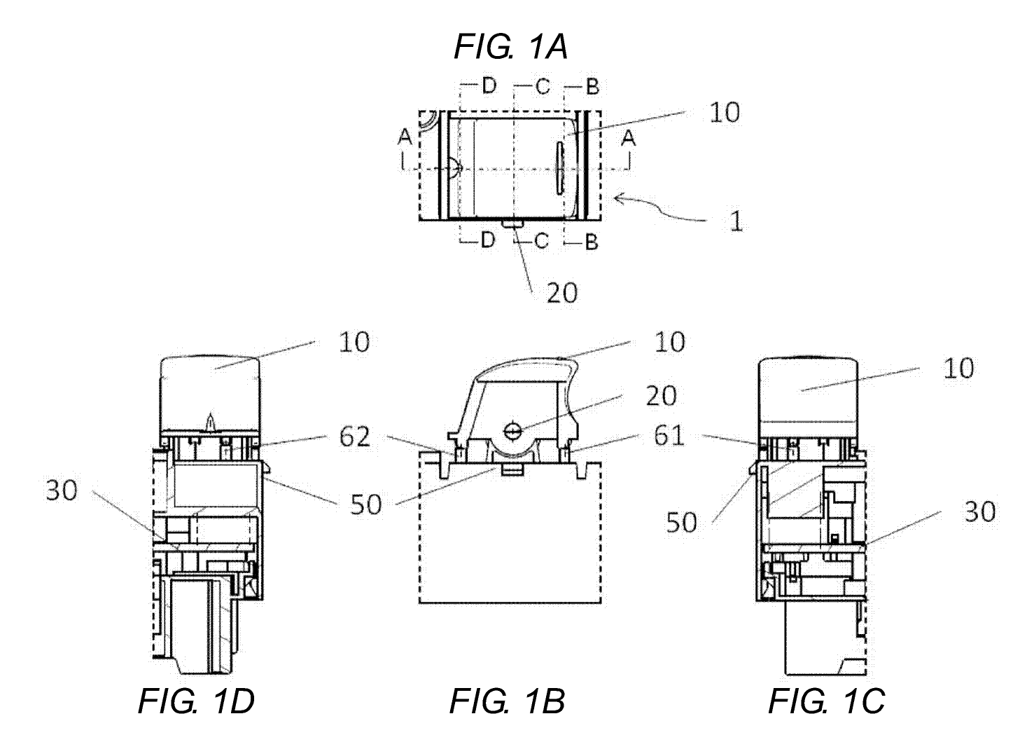

FIG. 1 shows a switch device 1 according to a first embodiment of the present invention. The switch device 1 has an operation knob 10 used when a user of a vehicle operates a power window, a supporting shaft 20 swingably supporting the operation knob 10, a case 50 including the supporting shaft 20, and a board 30 formed with circuits, which board is roughly parallel to the supporting shaft 20. Being roughly parallel does not mean being strictly parallel, but means being parallel in a permissible range as being almost parallel in the present technical field. The operation knob 10 is formed with a curvature on which a finger is easily put on a front surface side (on a side of a traveling direction of the vehicle) so as to make it easy for the user of the vehicle to operate the operation knob 10. The operation knob 10 is supported by the supporting shaft 20 so as to swing right and left in a side view (B)

For example, when the user pushes the operation knob 10 so as to incline the operation knob 10 on a right side (on the side of a traveling direction of the vehicle) in the side view (B), the operation knob 10 rotates around the supporting shaft 20 to be inclined on the right side, and at the same time, press down an internal first operation rod 61. Conversely, when the user pushes the operation knob 10 so as to incline the operation knob 10 on a left side (on an opposite side of the traveling direction of the vehicle), the operation knob 10 rotates around the supporting shaft 20 to be inclined on the left side, and at the same time, presses down an internal second operation rod 62.

In this manner, the switch device 1 operates the operation rods by the right and left swing in the side view (B) of the operation knob 10, and further, operates push button switches, as described later.

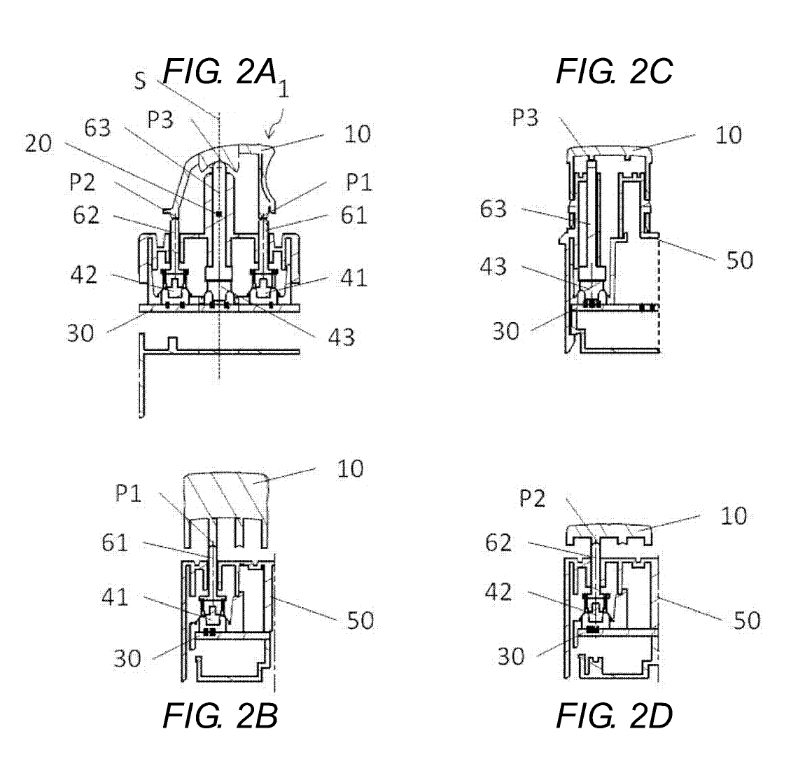

While the operation knob 10 is exposed from the case 50 for the user of the vehicle to operate, the board 30, the operation rods (61 and 62) and the like are contained in the case 50. Referring to cross-sectional views of FIGS. 2A to 2D, a structure of an inside of the case 50 will be described in detail. FIG. 2A is a cross-sectional view along a cross-sectional line A-A shown in FIG. 1A, FIG. 2B is a cross-sectional view along a cross-sectional line B-B shown in FIG. 1A, FIG. 2C is a cross-sectional view along a cross-sectional line C-C shown in FIG. 1A, and FIG. 2D is a cross-sectional view along a cross-sectional line D-D shown in FIG. 1A. In FIG. 2A, the supporting shaft 20 and a virtual surface S that includes the supporting shaft 20 and is perpendicular to the board 30, which cannot be originally seen, are shown for description.

The switch device 1 has a first push button switch 41 and a second push button switch 42 installed on the board 30 with the supporting shaft 20 interposed therebetween, and further, a third push button switch 43 on the board 30 in the vicinity of a central portion between the first push button switch 41 and the second push button switch 42. In other words, the first push button switch 41 is located on one side of the surface S (on the side of the traveling direction of the vehicle), the second push button switch 42 is located on another side of the surface S (on the opposite side of the traveling direction of the vehicle), and the third push button switch 43 intersects the surface S and is located closest to the supporting shaft 20 as compared with positions of the first push button switch 41 and the second push button switch 42.

Moreover, the switch device 1 has, inside the case 50, the first operation rod 61 that abuts on a lower surface of the operation knob 10 to transmit a changed amount of the inclination of the operation knob 10 on the right side (on the side of the traveling direction of the vehicle) to the first push button switch 41, and the second operation rod 62 that abuts on the lower surface of the operation knob 10 to transmit a changed amount of the inclination of the operation knob 10 on the left side (on the opposite side of the traveling direction of the vehicle) to the second push button switch 42. Furthermore, the switch device 1 has, inside the case 50, the third operation rod 63 that abuts on the lower surface of the operation knob 10 to transmit a changed amount of the inclination of the operation knob 10 on the right side (on the side of the traveling direction of the vehicle) and on the left side (on the opposite side of the traveling direction of the vehicle) to the third push button switch 43.

In other words, in the operation knob 10, a first point of effort P1 for pressing down the first push button switch 41 with the inclination on the right side is provided on the lower surface of the operation knob 10 and on the one side (on the side of the traveling direction of the vehicle), spaced from the surface S. Moreover, a second point of effort P2 for pressing down the second push button switch 42 with the inclination on the left side is provided on the lower surface of the operation knob 10 and on the other side (on the opposite side of the traveling direction of the vehicle), spaced from the surface S. Furthermore, in the switch device 1, a third point of effort P3 for pressing down the third push button switch 43 with the inclination on both the right and left sides is provided on the lower surface of the operation knob 10, and in the vicinity of the surface S.

The switch device 1 has the first operation rod 61, the second operation rod 62, and the third operation rod 63, which transmit forces to the first push button switch 41 from the first point of effort P1 of the operation knob 10, to the second push button switch 42 from the second point of effort P2 of the operation knob 10, and to the third push button switch 43 from the third point of effort P3 of the operation knob 10, respectively, so that the respective push button switches are operated with the changed amounts of the inclination of the operation knob 10.

In one or more embodiments of the present invention, the first operation rod 61 abuts on the operation knob 10 at P1, and the second operation rod 62 abuts on the operation knob 10 at P2 at almost the same height from the board 30, and as a result, the first operation rod 61 and the second operation rod 62 have almost the same length. However, embodiments of the present invention are not limited thereto, but the heights of P1 and P2 from the board 30 may be different, and the lengths of the first operation rod 61 and the second operation rod 62 may be different.

Moreover, a height from the board 30 of the third point of effort P3, which is a point where the third operation rod 63 and the operation knob 10 abut on each other, is located higher than the first point of effort P1 and the second point of effort P2, and a length of the third operation rod 63 is longer than the lengths of the first operation rod 61 and the second operation rod 62. However, similarly, embodiments of the present invention are not limited thereto, but the position of the third point of effort P3 may be at about the same height as, or lower than those of the first point of effort P1 and the second point of effort P2, or the third operation rod 63 may have almost the same length as, or a shorter length than those of the first operation rod 61 and the second operation rod 62.

Moreover, while the position of the third point of effort P3 is higher than the supporting shaft 20, embodiments of the present invention are not limited thereto, but the position thereof may be lower than the supporting shaft 20.

As to a shape of the portion of the lower surface of the operation knob 10 in contact with the third operation rod 63, which is the third point of effort P3, a distance from the supporting shaft 20 to the third point of effort P3 becomes longer as it becomes closer to the surface S, while the distance becomes shorter as it becomes away from the surface S, in the side view (FIG. 2A). That is, the shape of the portion in contact with the third operation rod 63 is a shape in which the distance from the supporting shaft 20 to the portion in contact becomes shorter as swing inclination of the operation knob 10 becomes larger. Because the portion in contact has the above-described shape, this portion in contact presses down the third operation rod 63 in accordance with the inclination of the right and left swing of the operation knob 10. As a result, the third operation rod 63 can operate conduction/cutoff of the third push button switch 43.

While in one or more embodiments of the present invention, the portion in contact with the third operation rod 63 is formed into a symmetrical shape with respect to the surface S, embodiments of the present invention are not limited thereto, but even when it has an asymmetrical shape, the third push button switch 43 and the first push button switch 41 or the second push button switch 42 only need to function in two stages.

In order that the third push button switch 43 and the first push button switch 41, or the third push button switch 43 and the second push button switch 42 function in the two stages, a magnitude of the inclination by the swing of the operation knob 10 that conducts or cuts off the first push button switch 41 and the second push button switch 42 is smaller or larger than a magnitude of the inclination by the swing of the operation knob 10 that conducts or cuts off the third push button switch 43. That is, when the magnitude of the inclination by the swing of the operation knob 10 that conducts or cuts off the first push button switch 41 and the second push button switch 42 is not equal to the magnitude of the inclination by the swing of the operation knob 10 that conducts or the cuts off the third push button switch 43, the switch device functions in the two stages.

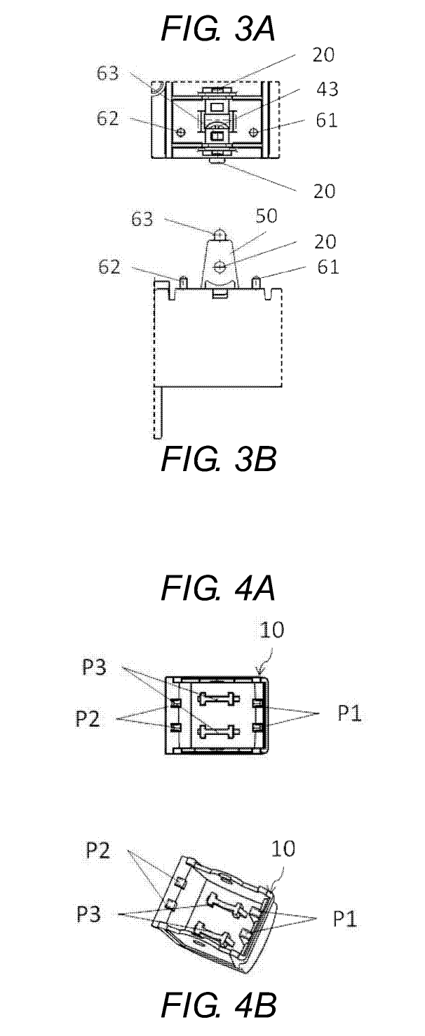

FIGS. 3A and 3B show the switch device 1 in a state where the operation knob 10 is not attached. While terminal ends of the first operation rod 61 and the second operation rod 62 each have a hemispherical shape, embodiments of the present invention are not limited thereto, and the shape only needs to allow a force to be transmitted from the lower surface of the operation knob 10 as the point of effort. Moreover, a terminal end of the third operation rod 63 has a shape of a side surface of a cylinder so as to conform with the shape of the portion of the lower surface of the operation knob 10 in contact with the third operation rod 63. However, embodiments of the present invention are not limited thereto, but any shape that allows the force to be transmitted from the portion in contact as the point of effort may be employed.

The case 50 is formed so as to surround the third operation rod 63, and includes the supporting shaft 20 in side surfaces. This supporting shaft 20 is a central shaft of the swing of the operation knob 10. The third push button switch 43 is shown under the third operation rod 63 inside the case 50.

FIGS. 4A and 4B each show the lower surface of the operation knob 10. The portions in contact with the third operation rod 63 as the third points of effort P3 are formed in a central portion, and the portions in contact with the first operation rods 61 and the second operation rods 62 as the first points of effort P1 and the second points of effort P2 are formed in both end portions. While in one or more embodiments of the present invention, the two portions in contact are provided, respectively, and this is because the switch device is formed to be generally used for the right and left doors, the number of the respective portions in contact may be one.

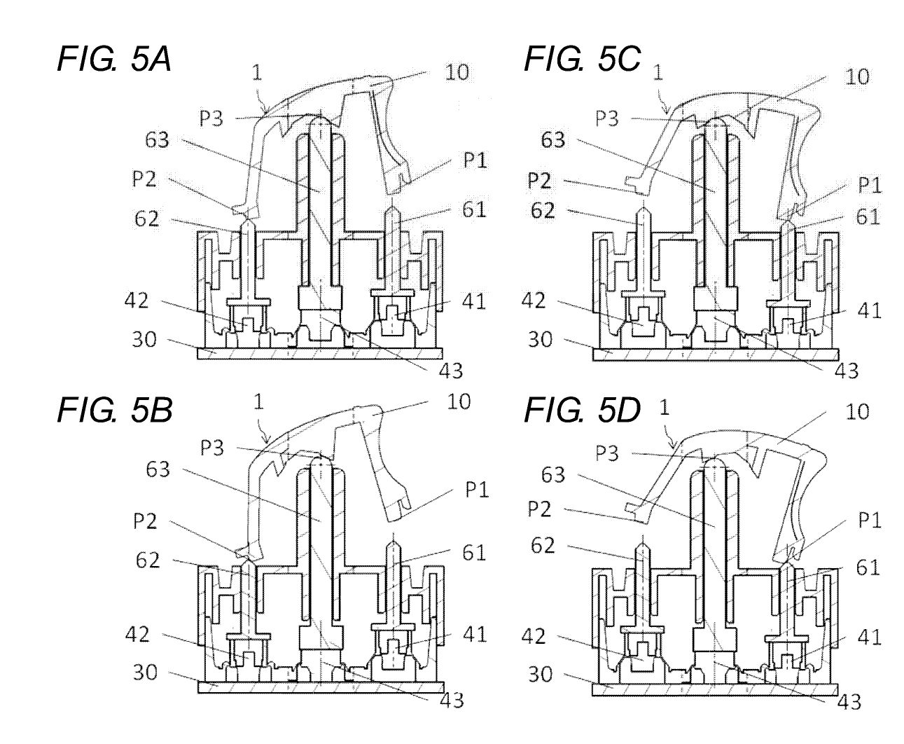

FIGS. 5A to 5D are cross-sectional views for describing operation of the switch device 1. FIG. 5A shows manual-up, FIG. 5B shows auto-up, FIG. 5C shows manual-down, and FIG. 5D shows auto-down. In FIGS. 5A and 5B, the operation knob 10 is inclined on the left side (on the opposite side of the traveling direction of the vehicle) in the side view to close the power window. In FIGS. 5C and 5D, the operation knob 10 is inclined on the right side (on the side of the traveling direction of the vehicle) in the side view to open the power window.

In FIG. 5A, inclining the operation knob 10 on the left side causes the second operation rod 62 to be pressed down at the second point of effort P2, and as a result, the second operation rod 62 operates the second push button switch 42, and the second push button switch 42 is conducted or cut off. At this stage, while the third operation rod 63 is also slightly pressed down at the third point of effort P3, the conduction or cutoff of the third push button switch 43 is not achieved. Here, when the user leaves a finger from the operation knob 10, the closing motion of the power window is stopped.

In FIG. 5B, further inclining the operation knob 10 on the left side causes the third operation rod 63 to be further pressed down at the third point of effort P3, while maintaining the state of the second push button switch 42, and as a result, the third operation rod 63 operates the third push button switch 43, and the third push button switch 43 is conducted or cut off. At this stages, the second push button switch 42 and the third push button switch 43 are simultaneously conducted or cut off, which enables the two-stage operation. Here, even if the user leaves his or her finger from the operation knob 10, the closing motion of the power window is not stopped.

In FIG. 5C, inclining the operation knob 10 on the right side causes the first operation rod 61 to be pressed down at the first point of effort P1, and as a result, the first operation rod 61 operates the first push button switch 41, and the first push button switch 41 is conducted or cut off. At this stage, while the third operation rod 63 is also slightly pressed down at the third point of effort P3, the conduction or cutoff of the third push button switch 43 is not achieved. Here, when the user leaves his or her finger from the operation knob 10, an opening motion of the power window is stopped.

In FIG. 5D, further inclining the operation knob 10 on the right side causes the third operation rod 63 to be pressed down at the third point of effort P3, while maintaining the state of the first push button switch 41, and as a result, the third operation rod 63 operates the third push button switch 43, and the third push button switch 43 is conducted or cut off. At this stages, the first push button switch 41 and the third push button switch 43 are simultaneously conducted or cut off, which enables the two-stage operation. Here, even if the user leaves his or her finger from the operation knob 10, the opening motion of the power window is not stopped.

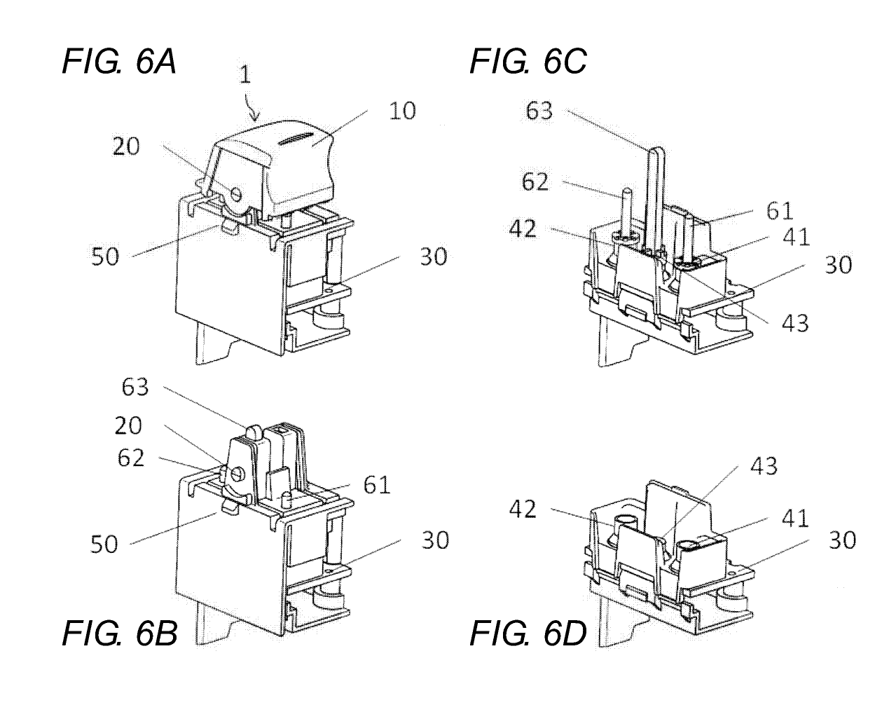

FIGS. 6A to 6D are perspective views showing the switch device 1, FIG. 6A showing the whole, FIG. 6B showing a state where the operation knob 10 is removed, FIG. 6C showing a state where the side surfaces of the case 50 are removed, and FIG. 6D showing a state where the operation rods (61, 62, 63) are removed. The operation knob 10 is supported swingably by the supporting shaft 20 included in the case 50. Under the operation knob 10, the first operation rod 61, the second operation rod 62, the third operation rod 63 are included, and the respective operation rods are supported slidably by respective portions of the case 50.

Under the first operation rod 61, the second operation rod 62, and the third operation rod 63, the first push button switch 41, the second push button switch 42, the third push button switch 43 are included. When each of the push button switches is operated, a circuit on the board is conducted or cut off.

### Second Embodiment

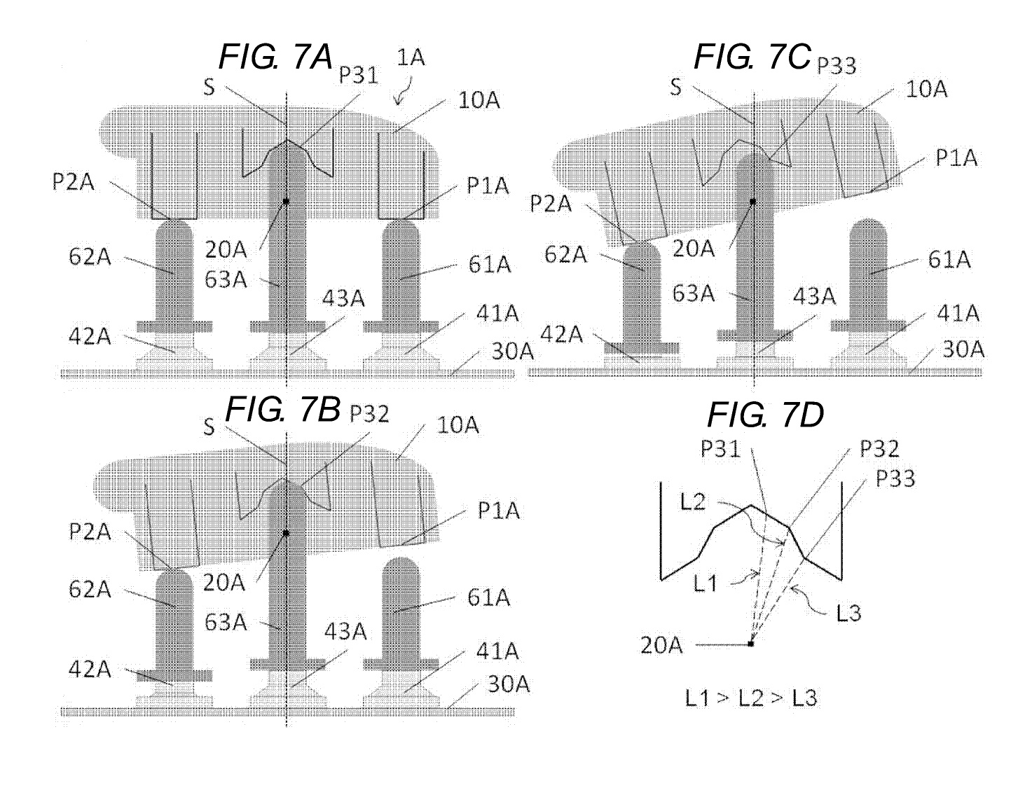

FIGS. 7A to 7D are explanatory views showing operation of a switch device 1A in one or more embodiments of the present invention. FIG. 7A is a view showing a neutral state, FIG. 7B is a view showing a state where a first stage is conducted, FIG. 7C is a state where a second stage is conducted, and FIG. 7D is an enlarged view of the portion where the operation rod and the lower surface of the operation knob come into contact with each other. In FIGS. 7A to 7D, a supporting shaft 20A and the virtual surface S that includes the supporting shaft 20A and is perpendicular to a board 30A, which cannot be originally seen, are shown for description.

The switch device 1A has an operation knob 10A used when a user of a vehicle operates a power window, the supporting shaft 20A swingably supporting the operation knob 10A, a case 50A (not shown) including the supporting shaft 20A, and the board 30A formed with a circuit, which board is roughly parallel to the supporting shaft 20A. The operation knob 10A is supported by the supporting shaft 20A so as to swing right and left around the supporting shaft 20A. While in the present figures, only a case where the operation knob 10A is inclined on the left side will be described, a case where the operation knob 10A is inclined on the right side is similar.

FIG. 7A shows the state where the user does not operate the operation knob 10A, that is, the so-called neutral state. Three push button switches 41A, 42A, and 43A are included on the board 30A. The push button switch 43A is provided almost under the supporting shaft 20A so as to intersect the surface S. The push button switches 41A and 42A are provided almost under both ends of the operation knob 10A with the push button switch 43A interposed therebetween.

On the three push button switches 41A, 42A, and 43A, operation rods 61A, 62A, and 63A are provided, respectively. An upper end of the operation rod 61A abuts on a point of effort PIA of the operation knob 10A, and an upper end of the operation rod 62A abuts on a point of effort P2A of the operation knob 10A, and an upper end of the operation rod 63A abuts on a point of effort P31 of the operation knob 10A. In this neutral state, forces do not strongly act on any of the points of effort, and the operation rods 61A, 62A, and 63A are in a state where they are in slight contact with the operation knob 10A at the points of effort P1A, P2A, and P31.

FIG. 7B shows a state where the user pushes down the operation knob 10A so as to incline the operation knob 10A on the left side. The operation knob 10A is inclined on the left side by rotating around the supporting shaft 20A, and at the same time, presses down the operation rod 62A, so that the operation rod 62A transmits a force with which the user pushes down the operation knob 10A to the push button switch 42A, thereby pressing down the push button switch 42A by a movement distance by which the user pushes down, because the operation rod 62A is rigid. This pressing down of the push button switch 42A allows the push button switch 42A to be operated, thereby conducting or cutting off the circuit of the board 30A.

On the other hand, the upper end of the operation rod 63A abuts on the lower surface of the operation knob 10A at a point of effort 32. Here, referring to FIG. 7D, a relationship between the points of effort P31 and P32 will be described. As to a shape of the portion of the lower surface of the operation knob 10A, on which the operation rod 63A abuts, a distance from the supporting shaft 20A to the point of effort becomes longer as it becomes closer to the surface S, while the distance becomes shorter as it becomes away from the surface S, in the side view. In other words, the shape of the portion abutting on the operation rod 63A is a shape in which as the inclination of the swing of the operation knob 10A becomes larger, the distance from the supporting shaft 20A to the abutting portion becomes shorter.

That is, as shown in FIG. 7D, as to a distance L1 between the point of effort P31 when the operation knob 10A is in the neutral state (the state of (A)) and the supporting shaft 20A, and a distance L2 between the point of effort P32 when the operation knob 10A is inclined on the left side (the state of (B)) and the supporting shaft 20A, a relationship of L1>L2 is established. Accordingly, since the operation knob 10A is fixed by the supporting shaft 20A, the lower surface of the operation knob 10A presses down the operation rod 63A. However, at this stage, the movement distance of the operation rod 63A is not enough to operate the push button switch 43A, and the push button switch 43A is not conducted or cut off.

Moreover, the upper end of the operation rod 61A and the lower surface of the operation knob 10A are away from each other because the operation knob 10A is inclined left, and at this stage, the point of effort PIA does not function as the point of effort. Accordingly, at this stage, only the push button switch 42A is conducted or cut off, and functions as the switch at the first stage.

FIG. 7C shows a state where the user pushes down the operation knob 10A so as to further incline the operation knob 10A on the left side. The operation knob 10A is further inclined on the left side by rotating around the supporting shaft 20A, and at the same time, presses down the operation rod 62A, so that the operation rod 62A transmits a force with which the user pushes down to the push button switch 42A, thereby pressing down the push button switch 42A by the movement distance by which the user pushes down, because the operation rod 62A is rigid. However, because the push button switch 42A has already be in the conducted or cut-off state, further switch operation does not occur.

On the other hand, the upper end of the operation rod 63A abuts on the lower surface of the operation knob 10A at a point of effort P33. As shown in FIG. 7D, as for the distance L2 between the point of effort P32 when the operation knob 10A is inclined on the left side at one stage (the state of (B)) and the supporting shaft 20A, and a distance L3 between the point of effort P33 when the operation knob 10A is further inclined on the left side (the state of (C)) and the supporting shaft 20A, a relationship of L2>L3 is established. Accordingly, because the operation knob 10A is fixed by the supporting shaft 20A, the lower surface of the operation knob 10A further presses down the operation rod 63A. Because the operation rod 63A is rigid, the push button switch 43A is further pressed down by a movement distance of L2-L3. This pressing down of the push button switch 43A allows the push button switch 43A to be operated, thereby conducting or cutting off the circuit of the board 30A.

Because the portion of the lower surface of the operation knob 10A abutting on the operation rod 63A has the shape meeting L1>L2>L3, this abutting portion presses down the operation rod 63A by the inclination of the right and left swing of the operation knob 10A. As a result, the operation rod 63A can operate the conduction/cutoff of the push button switch 43A. In this manner, the inclination by the swing of the operation knob 10A that conducts or cuts off the push button switch 42A, and the inclination by the swing of the operation knob 10A that conducts or cuts off the push button switch 43A are different, which enables the switch operation in the switch device 1A in the two stages.

One or more embodiments of the present invention are characterized in that the inclination by the swing of the operation knob 10A that conducts or cuts off the push button switch 42A is smaller than the inclination by the swing of the operation knob 10A that conducts or cuts off the push button switch 43A.

The present invention is not limited to the exemplified embodiments, but can be carried out with a constitution of a range not departing from the contents described in respective claims. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A switch device comprising:
an operation knob;
a supporting shaft that swingably supports the operation knob;
a board substantially parallel to the supporting shaft;
a first push button switch located on one side of a surface that includes the supporting shaft and is perpendicular to the board, and provided on the board to be operated by swing of the operation knob;
a second push button switch located on another side of the perpendicular surface, and provided on the board to be operated by the swing of the operation knob; and
a third push button switch intersecting the perpendicular surface, and provided on the board to be operated by the swing of the operation knob,
wherein a first point of effort of a force acting on the first push button switch in the operation knob is located on the one side, spaced from the perpendicular surface,
a second point of effort of a force acting on the second push button switch in the operation knob is located on the other side, spaced from the perpendicular surface, and
a third point of effort of a force acting on the third push button switch in the operation knob is located in the vicinity of the perpendicular surface.

2. The switch device according to claim 1, further comprising:
a case including the supporting shaft;
a first operation rod that transmits the force from the first point of effort to the first push button switch;
a second operation rod that transmits the force from the second point of effort to the second push button switch; and
a third operation rod that transmits the force from the third point of effort to the third push button switch,
wherein the board, the first operation rod, the second operation rod, and the third operation rod are arranged inside the case,
the first operation rod and a lower surface of the operation knob, and the second operation rod and the lower surface of the operation knob are in contact with each other, and
a portion where the third operation rod and the lower of the operation knob are in contact with each other, which is the third point of effort, has a shape in which as inclination of the swing of the operation knob becomes larger, a distance from the supporting shaft to the portion in contact becomes shorter.

3. The switch device according to claim 1, wherein a magnitude of the inclination by the swing of the operation knob that conducts or cuts off each of the first push button switch and the second push button switch is smaller than a magnitude of the inclination by the swing of the operation knob that conducts or cuts off the third push button switch.

4. The switch device according to claim 1,
wherein the first push button switch is conducted or cut off by inclining the operation knob in one direction, and a third push button switch is conducted or cut off by further inclining the operation knob in the one direction,
while the second push button switch is conducted or cut off by inclining the operation knob in another direction, and the third push button switch is conducted or cut off by further inclining the operation knob in the other direction.

5. A switch device comprising:
an operation knob;
a supporting shaft that swingably supports the operation knob;
a board substantially parallel to the supporting shaft;
a first push button switch located on one side of a surface that includes the supporting shaft and is perpendicular to the board, and provided on the board to be operated by swing of the operation knob;
a second push button switch located on another side of the perpendicular surface, and provided on the board to be operated by the swing of the operation knob;
a third push button switch intersecting the perpendicular surface, and provided on the board to be operated by the swing of the operation knob;
a first operation rod that is provided on the one side of the perpendicular surface, and presses the first push button switch by inclination in a first direction of the operation knob;
a second operation rod that is provided on the other side of the perpendicular surface, and presses the second push button switch by inclination in a second direction of the operation knob; and
a third operation rod that is provided at a position intersecting the perpendicular surface, and presses the third push button switch by the inclination in the first or second direction of the operation knob.

6. The switch device according to claim 2, wherein a magnitude of the inclination by the swing of the operation knob that conducts or cuts off each of the first push button switch and the second push button switch is smaller than a magnitude of the inclination by the swing of the operation knob that conducts or cuts off the third push button switch.

7. The switch device according to claim 2,
wherein the first push button switch is conducted or cut off by inclining the operation knob in one direction, and a third push button switch is conducted or cut off by further inclining the operation knob in the one direction,
while the second push button switch is conducted or cut off by inclining the operation knob in another direction, and the third push button switch is conducted or cut off by further inclining the operation knob in the other direction.

8. The switch device according to claim 3,
wherein the first push button switch is conducted or cut off by inclining the operation knob in one direction, and a third push button switch is conducted or cut off by further inclining the operation knob in the one direction,
while the second push button switch is conducted or cut off by inclining the operation knob in another direction, and the third push button switch is conducted or cut off by further inclining the operation knob in the other direction.
